(19) United States
(12) Patent Application Publication
(10) Pub. No.: US 2007/0019277 A1
(43) Pub. Date: Jan. 25, 2007

(54) Forward and reverse scanning-type display device

(75) Inventors: In Jae Yeo, Yongin-si (KR); Kyu Bum Han, Suwon-si (KR); Seung Won Ryu, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/486,835

(22) Filed: Jul. 14, 2006

(30) Foreign Application Priority Data
Jul. 20, 2005 (KR) 10-2005-0065835

(51) Int. Cl. G02B 26/00

(52) U.S. Cl. 359/291

(57) ABSTRACT

Disclosed herein is a forward and reverse scanning-type display device using a diffractive optical modulator. The display device includes a light source system, one or more illumination optical units, a diffractive optical modulator, a projection and scanning optical unit and a display electronic system. The light source system radiates light. The illumination optical units convert the light into linear incident light. The diffractive optical modulator modulates the linear incident light into linear diffracted light in response to driving signals. The projection and scanning optical unit creates an image by repeatedly and alternately scanning the linear diffracted light on a screen in a first direction and in a reverse direction. The display electronic system outputs the driving signals to the diffractive optical modulator in intervals for the scanning in the first and reverse directions and, thereby, controls the diffractive optical modulator such that the diffractive optical modulator can create linear diffracted light in the intervals for the scanning in the first and reverse directions.

### BACKGROUND OF THE INVENTION

1. Field of the Invention

The present invention relates generally to a display device using a diffractive optical modulator and, more particularly, to a forward and reverse scanning-type display device that enables scanning in both forward and reverse directions when scanning linear diffracted light, which is modulated in a diffractive optical modulator, onto a screen.

2. Description of the Related Art

With the development of microtechnology, so-called Micro-Electro-Mechanical Systems (MEMS) devices, and small-sized equipment into which such MEMS devices are incorporated are attracting attention.

A MEMS device is formed on a substrate, such as a silicon substrate or a glass substrate, in a microstructure form, and is a device in which an actuator for outputting a mechanical actuating force and a semiconductor Integrated Circuit (IC) for controlling the operation of the actuator are electrically or mechanically combined. The basic feature of such a MEMS device is that an actuator having a mechanical structure is included as part of the device. The actuator is electrically operated using Coulomb's force between electrodes.

Recently, a diffractive optical modulator using such MEMS devices has been developed. FIG. 1A and FIG. 1B illustrate the construction of a Grating Light Valve (GLV) 11 that was developed as a prior art diffractive optical modulator.

The GLV 11, as illustrated in FIG. 1A, is constructed in such a way that a shared substrate electrode 13 is formed on an insulated substrate 12, such as a glass substrate, and beams 24, six such beams 14 in the present embodiment (14₁, 14₂, 14₃, 14₄, 14₅ and 14₆), are arranged parallel to each other across the substrate electrode 13 in a bridge form.

The beams 14, each of which is composed of a bridge member and a combined reflecting film and actuation electrode 16 disposed on the bridge member, are commonly called “ribbons.”

When a small amount of voltage is applied between the substrate electrode 13 and the combined reflecting film and actuation electrode 16, the beams 14 are moved toward the substrate electrode 13 due to the above-described electrostatic phenomenon. In contrast, when the application of the voltage is stopped, the beams 14 are separated from the substrate electrode 13 and return to the initial positions thereof.

In the GLV 11, the heights of the actuation electrodes are alternately changed by an operation in which the beams 24 are moved toward or separated from the substrate electrode 13 (that is, the movement of the beams 14 toward the substrate electrode 13 and the separation of the beams 24 from the substrate electrode 13) and the intensity of light reflected by the actuation electrodes is modulated by the diffraction of light (a single light spot is radiated for a total of six beams 24).

Meanwhile, the above-described diffractive optical modulator may be used in various application fields, for example, a display device field.

Generally, a display device using the prior art diffractive optical modulator includes a light source, an illumination lens, a diffractive optical modulator, a projection system, and a screen.

The light source includes a plurality of light sources, for example, a red light source, a green light source and a blue light source.

The illumination lens converts light emitted from the light source into linear parallel light, and causes the parallel light to enter the diffractive optical modulator.

When the linear parallel light is incident on the diffractive optical modulator, the diffractive optical modulator performs optical modulation on the linear parallel light and, thus, produces diffracted light having a plurality of diffraction orders. In this case, diffracted light produced by the diffractive optical modulator forms linear diffracted light from a diffraction order standpoint. That is, with respect to diffracted light emitted from the diffractive optical modulator, in order to form the pixels of an image formed on a screen, a plurality of corresponding diffracted scanning point beams is gathered together, is linearly arranged, and forms a linear scanning line.

The projection system projects and scans a linear scanning line, which is formed by linearly arranging a plurality of diffracted scanning point beams, onto the screen, thereby creating a two-dimensional image.

As an example, in the case of universal HDTV standards, a single frame image has a row length (K)=1080 pixels and a column length (L)=1920 pixels. In order to output HDTV-class images using the above-described diffractive optical modulator, a two-dimensional image is formed by scanning a linear scanning line, which is formed by linearly arranging diffracted scanning point beams corresponding to 1080 pixels, in a lateral direction.

Meanwhile, the conventional scanning scheme of creating a two-dimensional image by scanning a linear scanning line in a lateral direction must perform three operations of scanning the linear scanning line so as to display a color image on a screen. In order to enable the high-speed linear scanning of a scanning line, the scanner is designed to be able to rapidly decelerate at the time of returning in the reverse direction.

However, the above-described rapid deceleration that is performed when the scanner returns in the reverse direction has the problems of incurring high power consumption and hastening the wear of the scanner. Furthermore, the above-described rapid deceleration is disadvantageous in that brightness is low because the ratio of the effective projection period of the projection of image information onto a screen to the total period of the projection of light onto the screen is low, and the contrast ratio of an image is low unless light sources are not turned off when the scanner returns in the reverse direction.

### SUMMARY OF THE INVENTION

Accordingly, the present invention has been made keeping in mind the above problems occurring in the prior art, and an object of the present invention is to provide a forward and reverse scanning-type display device that, at the time of scanning light, which is diffracted by a diffractive optical modulator, onto a screen, can reduce the acceleration and deceleration the time period of a scanner, increase the ratio of an effective projection period during which image information is projected onto a screen, and improve the contrast ratio of an image.

In order to accomplish the above object, the present invention provides a forward and reverse scanning-type display device using a diffractive optical modulator, including a light source system for creating and radiating light; one or more illumination optical units for converting the light, which is emitted from the light source system, into linear incident light; a diffractive optical modulator for modulating the linear incident light, which is emitted from the illumination optical units, into linear diffracted light in response to driving signals; a projection and scanning optical unit for creating an image by repeatedly and alternately scanning the linear diffracted light, which is emitted from the diffractive optical modulator, on a screen in a first direction and in a reverse direction; and a display electronic system for outputting the driving signals to the diffractive optical modulator in intervals for the scanning in the first and reverse directions and, thereby, controlling the diffractive optical modulator such that the diffractive optical modulator can create linear diffracted light, including image information, in the intervals for the scanning in the first and reverse directions.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams showing a prior art grating light valve;

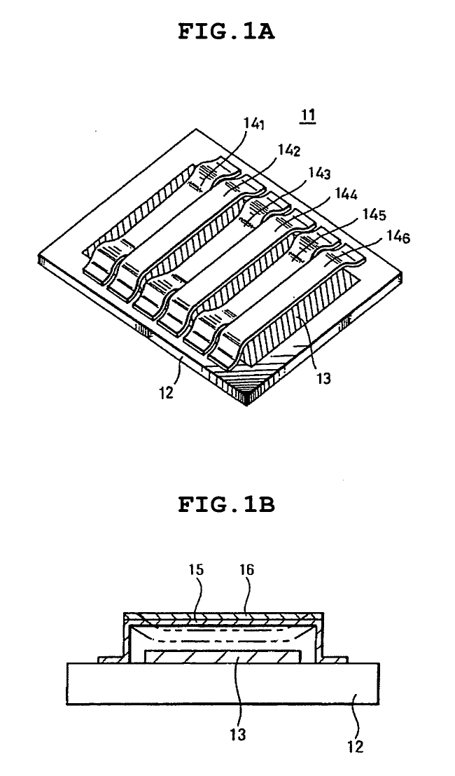

FIG. 2 is a diagram showing the construction of a forward and reverse scanning-type display device using a diffractive optical modulator according to an embodiment of the present invention;

FIG. 3 is a perspective view showing an embodiment of the open hole-based diffractive optical modulator of FIG. 2;

FIG. 4 is a plan view showing the open hole-based diffractive optical modulator of FIG. 3;

FIG. 5 is a diagram showing the detailed construction of the projection and scanning optical unit of FIG. 2;

FIG. 6 is a diagram showing a time-to-distance trajectory;

FIG. 7 is a diagram showing the construction of the display electronic system of FIG. 2; and

FIG. 8A is a diagram showing the structure of a single-frame image composed of 1080×1920 pixels, and FIG. 8B is a diagram in which input image data is transposed from a lateral arrangement to a vertical arrangement.

### DESCRIPTION OF THE PREFERRED EMBODIMENTS

Reference now should be made to the drawings, in which the same reference numerals are used throughout the different drawings to designate the same or similar components.

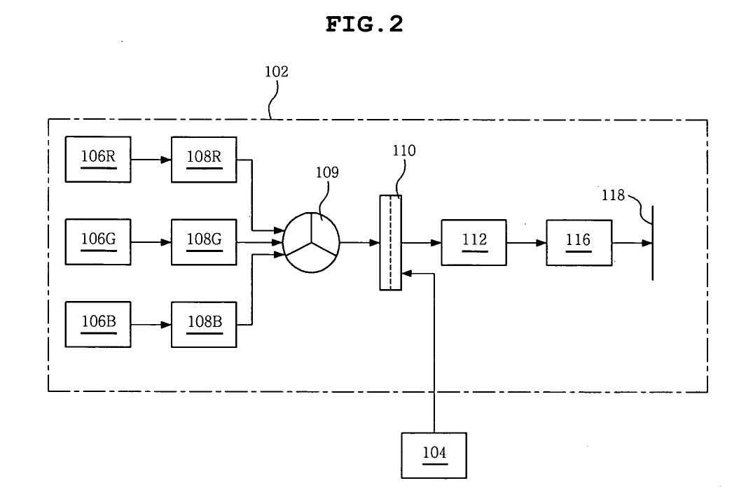

With reference to FIGS. 2 to 8B, a forward and reverse scanning-type display device according to a preferred embodiment of the present invention is described in detail.

FIG. 2 is a diagram showing the construction of the forward and reverse scanning-type display device using a diffractive optical modulator according to the embodiment of the present invention.

Referring to FIG. 2, the forward and reverse scanning-type display device using a diffractive optical modulator according to the embodiment of the present invention includes a display optical system 102 and a display electronic system 104.

The display optical system 102 includes a red light source 106R, a green light source 106G, a blue light source 106B, an illumination optical unit 108R for the red light source, an illumination optical unit 108G for the green light source, an illumination optical unit 108B for the blue light source, a plate-shaped color wheel 109, a diffractive optical modulator 110, a Schlieren optical unit 112, a projection and scanning optical unit 116, and a screen 118.

In this case, the laser light sources 106R, 106G and 106B radiate laser light. The cross section of radiated laser light is, for example, circular, and the intensity profile of the light has a Gaussian distribution.

The illumination optical units 108R, 108G and 108B convert light, which is radiated from the laser light sources 106R, 106G and 106B, into linear light so as to radiate narrow and long linear light onto the diffractive optical modulator 110.

The diffractive optical modulator 110 modulates linear light, which is radiated from the illumination optical units 108R, 108G and 108B, into diffracted light. In this case, the plate-shaped color wheel 109 is interposed between the illumination optical units 108R, 108G and 108B and the diffractive optical modulator 110, and is divided into three sections, each of which passes single color light therethrough. Accordingly, when the plate-shaped color wheel 109 rotates, and linear light beams, which are emitted from the illumination optical units 108R, 108G and 108B, have the same optical path, linear light, which passes through the plate-shaped color wheel 109 and enters the diffractive optical modulator 110, is time-divided. At this time, when, for example, the plate-shaped color wheel 109 is divided in the sequence of an R region, a G region and a B region, beams of light pass through the plate-shaped color wheel 109 in the sequence of R light, G light and B light. When the plate-shaped color wheel 109 is not employed, the same effect can be achieved by turning on and off the light sources 106R, 106G and 106B in a predetermined sequence.

As described above, when linear light incident on the diffractive optical modulator 110 is time-divided and passes therethrough, the diffractive optical modulator 110 performs optical modulation on incident light under the control of the optical modulator driving circuit (not shown) of the display electronic system 104, thereby creating and emitting diffracted light.

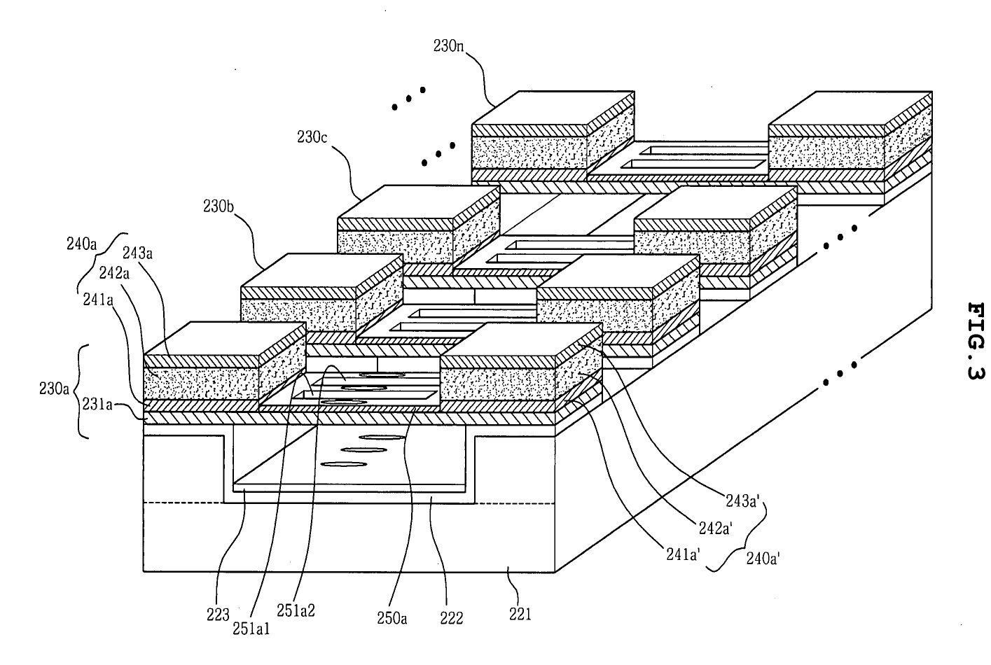

An example of the diffractive optical modulator 110 used herein is illustrated in FIG. 3. FIG. 3 shows an open hole-based diffractive optical modulator. Referring to FIG. 3, the open hole-based diffractive optical modulator includes a silicon substrate 221, an insulation layer 222, a lower reflection member 223, and a plurality of actuation elements 230a˜230n.

In this case, the lower reflection member 223 is deposited above the silicon substrate 221, and functions to reflect incident light. The lower reflection member 223 may be made of metal such as Al, Pt, Cr or Ag.

Each of the actuation elements (although only a description of an actuation element 230a is representatively given, the others have the same construction and function) has a ribbon shape. The actuation element 230a is provided with a lower support 231a, the lower surfaces of both ends of which are attached onto two sides of the silicon substrate 221 beside the recess of the silicon substrate 221 such that the center portion of the actuation element 230a is spaced apart from the recess of the silicon substrate 221.

Piezoelectric layers 240a and 240a′ are provided on the two sides of the lower support 231a, and generate the actuation force of the actuation element 230a through the contraction and expansion of the piezoelectric layers 240a and 240a′.

Furthermore, the left and right piezoelectric layers 240a and 240a′ include lower electrode layers 241a and 241a′ configured to provide piezoelectric voltage, piezoelectric material layers 242a and 242a′ disposed on the lower electrode layers 241a and 241a′ and configured to generate upward and downward actuation forces through the contraction and expansion thereof when voltage is applied to both surfaces thereof, and upper electrode layers 243a and 243a′ disposed on the piezoelectric material layers 242a and 242a′ and configured to provide piezoelectric voltage to the piezoelectric material layers 242a and 242a′. When voltage is applied to the upper electrode layers 243a and 243a′ and the lower electrode layers 241a and 241a′, the piezoelectric material layers 242a and 242a′ contract or expand, thus causing the lower support 231a to move upward or downward.

Meanwhile, an upper reflection member 250a is deposited on the center portion of the lower support 231a, and the lower support 231a is provided with a plurality of open holes 251a1 and 251a2.

These open holes 251a1 and 251a2 allow light incident on the actuation element 230a to pass therethrough and be incident on the portions of the lower reflection member 223 corresponding to the open holes 251a1 and 251a2, thereby enabling light reflected by the lower reflection member 223 and light reflected by the upper reflection member 250a to form diffracted light.

In this case, the incident light passing through the open holes 251a1 and 251a2 of the upper reflection member 250a can be incident on the corresponding portions of the lower reflection member 223. When the gap between the upper reflection member 250a and the lower reflection member 223 is an odd multiple of λ/4, maximally diffracted light is generated.

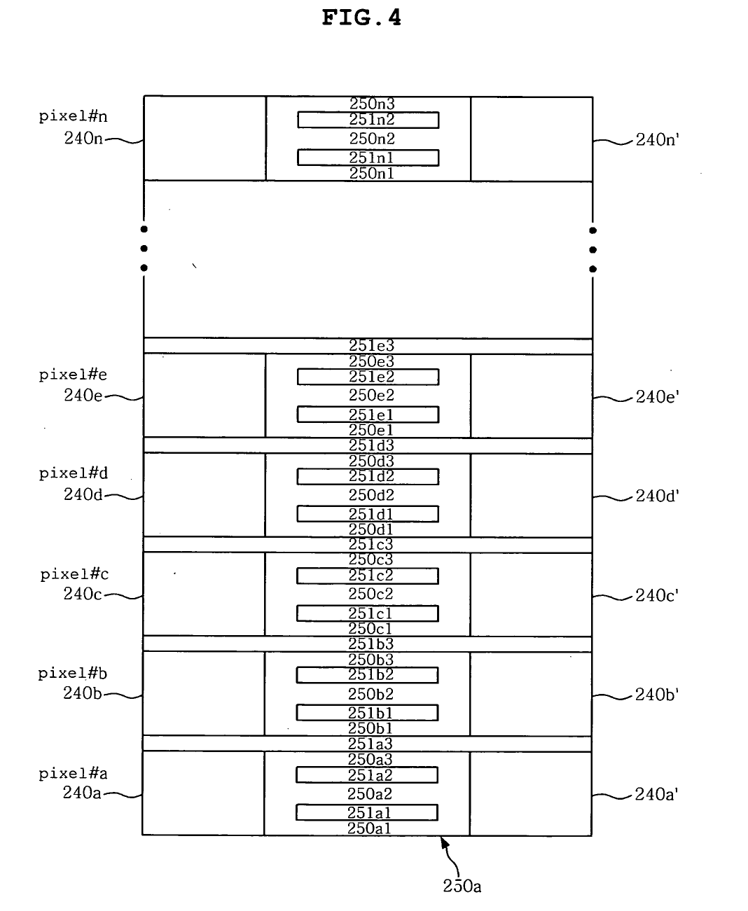

In that case, a single upper reflection member 250a and a corresponding lower reflection member 223 can form a diffracted scanning point beam that is used to form a pixel of an image formed on a screen. In more detail, referring to FIG. 4, the diffractive optical modulator 110 has n upper reflection members 250a˜250n that respectively correspond to the pixel a, pixel b, pixel c, pixel d, pixel e, . . . , pixel n of an image that is formed on the screen 118. Referring to the upper reflection member 250a, the diffractive optical modulator 110 allows light reflected by the reflection surfaces 250a1, 250a2 and 250a3 of the upper reflection member 250a and light passed through the open holes 251a1, 251a2 and 251a3 of the upper reflection member 250a (in this case, the term “open hole” 251a3 refers to the gap between the upper reflection member 250a and an adjacent upper reflection member 250b) and reflected by the lower reflection member 223 to form diffracted light. This diffracted light forms a diffracted scanning point beam that corresponds to a pixel of an image formed on the screen 118.

That is, each of the upper reflection members 250a˜250n, together with the reflecting surface of a corresponding lower reflection member 223, forms a diffracted scanning point beam that corresponds to a pixel of an image formed on the screen 118. Such diffracted scanning point beams are aligned in line and form a scanning line (in this case, it is assumed that a scanning line is composed of n diffracted scanning point beams that correspond to n pixels).

Thereafter, the Schlieren optical unit 112 (which can be referred to as an “a single surface filter unit”) separates diffracted light, which is modulated by the diffractive optical modulator 110, according to diffraction order, and passes diffracted light having desired diffraction orders, which belong to separated light having various diffraction orders, therethrough.

The Schlieren optical system 112, for example, includes a Fourier lens (not shown) and a spatial filter or dichroic filter (not shown), and functions to selectively pass 0-order diffracted light, or +1-order or −1-order diffracted light, which belongs to the incident diffracted light, therethrough.

Meanwhile, the projection and scanning optical unit 116 creates a two-dimensional image by scanning a scanning line, which is composed of a plurality of diffracted scanning point beams that have passed through the Schlieren optical unit 112, across the screen 118 in forward and reverse directions.

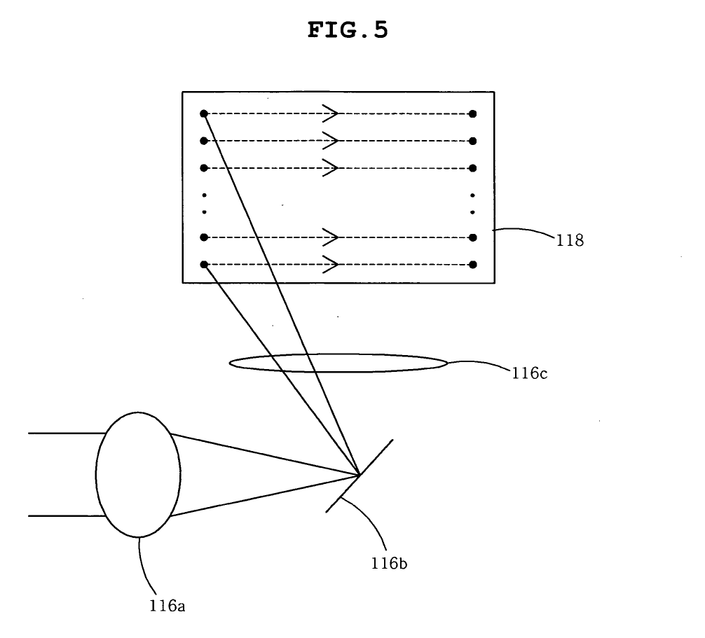

The projection and scanning optical unit 116, as illustrated in FIG. 5, includes a condenser lens 116a, a scanner 116b and a projection lens 116c, and functions to project incident diffracted light onto the screen 118.

In that case, the condenser lens 116a condenses linear diffracted light, which has passed through an optical filter or dichroic filter (not shown), such that it focuses on the screen 118. Also, it is possible to additionally provide a concave lens (not shown) behind the condenser lens 116a, thus condensing diffracted light, which has passed through the optical filter or dichroic filter (not shown), converting the condensed light into parallel light, and then projecting the parallel light onto the scanner 116b.

The scanner 116b is an X scanning mirror, and functions to scan an incident line image onto the screen 118 from the left to the right and then from the right to the left and repeat the above operation under the control of the display electronic system 104.

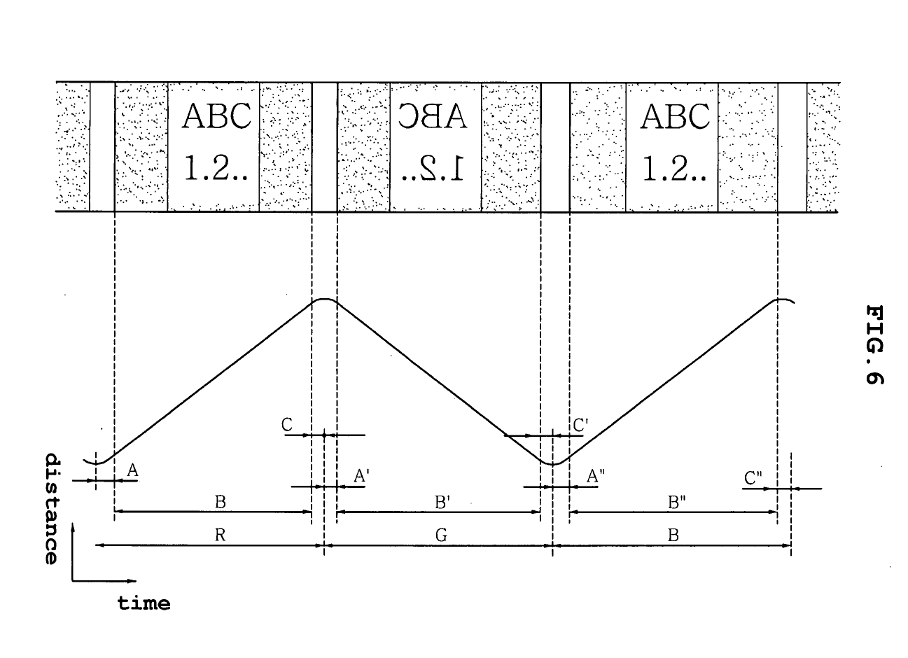

In this case, for example, as shown in the time-to-distance trajectory of FIG. 6, when a red color scanning line is scanned across the screen 118 when the scanner 116b performs a first forward scan from the left to the right, a green color scanning line is scanned across the screen 118 when the scanner 116b performs a reverse scan from the right to the left, and a blue color scanning line is scanned when the scanner 116a performs a second forward scan from the left to the right across the screen 118, a single color image composed of red, green and blue colors is completed. Thereafter, when the scanner 116b scans a red color scanning line in the reverse direction, a green color scanning line in the forward direction and a blue color scanning line in the reverse direction, another color image composed of red, green and blue colors is completed. When the above operations are repeatedly performed, a moving image can be displayed.

The time-to-distance scanner trajectory of FIG. 6 is described in more detail below. The time interval can be divided into a section R, a section G and a section B. The section R can be divided into a sub-section A, a sub-section B and a sub-section C, the section G can be divided into a sub-section A′, a sub-section B′ and a sub-section C′, and the section B can be divided into a sub-section A″, a sub-section B″ and a sub-section C″.

In this case, the section R is a forward scanning section, the section G is a reverse scanning section, and the section B is a forward scanning section.

In the section R, the sub-section A is a scanning preparation section, the section B is a forward scanning section, in which a scanning line is displayed on a screen, and the section C is an idle section.

In the section G, the sub-section A′ is a scanning preparation section, the sub-section B′ is a reverse scanning section, in which a scanning line-in this case, the scanning line is a scanning line having image information-is displayed on the screen, and the sub-section C′ is an idle section.

Furthermore, in the section B, the sub-section A″ is a scanning preparation section, the sub-section B″ is a second forward scanning section, in which a scanning line is displayed on a screen, and the sub-section C″ is an idle section.

As described above, when image information is included in scanning lines at the time of both forward scanning and reverse scanning, the present invention can create a screen that does not hinder humans from recognizing the screen, even though it performs scanning at a speed of 90 Hz. In contrast, the conventional art requires a speed of 180 Hz for a single forward scan.

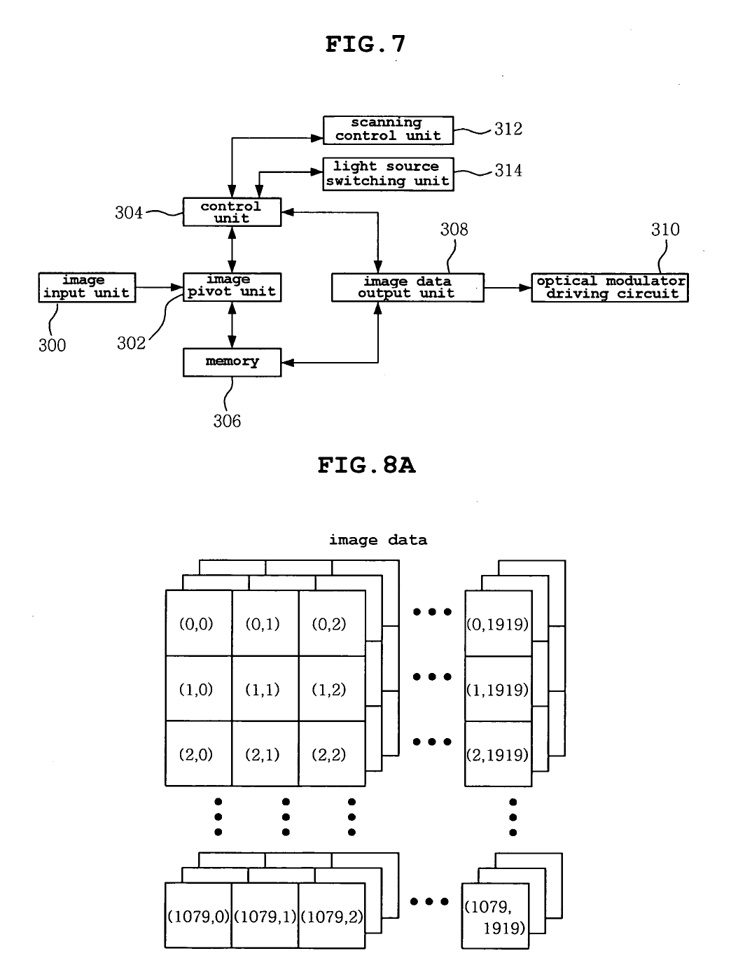

Meanwhile, the display electronic system 104, as shown in FIG. 7, includes an image input unit 300, an image pivot unit 302, a control unit 304, memory 306, an image data output unit 308, an optical modulator driving circuit 310, a scanning control unit 312, and a light source switching unit 314.

The image input unit 300 receives image data from outside, and also receives a vertical synchronization signal Vsync and a horizontal synchronization signal Hsync.

The image pivot unit 302 converts image data input in a lateral direction into image data arranged in a vertical direction by performing data transposition so as to transpose image data arranged in a lateral direction into image data arranged in a vertical direction, and then stores the image data in the memory 306. The reason why the image pivot unit 302 performs data transposition is that a scanning line emitted from the diffractive optical modulator 110 is configured to perform scanning and display in a lateral direction because the scanning line is composed of diffracted scanning point beams that correspond to 1080 pixels and are arranged in a vertical direction.

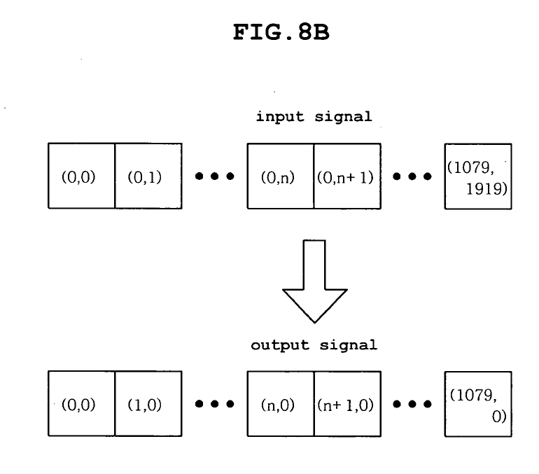

That is, as shown in FIG. 8A, standard image data is arranged in a lateral direction. In contrast, in the diffractive optical modulator 110, the plurality of actuation elements 230a˜230n are arranged in a vertical direction, as shown in FIG. 3, therefore a plurality of pieces of image data is scanned and displayed in a lateral direction.

Accordingly, in order to create a single-frame image, which is composed of 1080×1920 pixels, using the diffractive optical modulator 110 by scanning a scanning line, 1080 (an example of the number of pixels of an image arranged in a vertical direction) pieces of data, which are arranged in the vertical direction, are required.

In other words, FIG. 8A shows the structure of a single-frame image that is composed of 1080×1920 pixels. The image data shown in FIG. 8A is input from an outside in a lateral direction, that is, in the sequence of (0,0), (0,1), (0,2), (0,3), . . . .

Meanwhile, since 1080 pieces of data arranged in a vertical direction are required for the diffractive optical modulator 110, the input image data must be transposed from a lateral arrangement into a vertical arrangement, as shown in FIG. 8B.

The image data output unit 308 sequentially reads image data, which is transposed by the image pivot unit 302 and stored in the memory 306, from a first row to a last row and outputs it in a forward scanning section, and reads transposed data, which is stored in the memory 306, from a last row to a first row in the reverse direction and outputs it in a reverse scanning section. By doing so, an image, which is formed on the screen 118 at the time of reverse scanning, can be correctly created without being reversed. The timing between the scanning control unit and the image data output unit is controlled by the control unit 304 so that outputs for the same column (or, in the case of vertical scanning, the same row) coincide with each other on the screen at the time of forward and reverse scanning.

The optical modulator driving circuit 310 operates the diffractive optical modulator 110 according to the image data output from the image data output unit 308, so that the diffractive optical modulator 110 modulates incident light, thereby creating diffracted light having image information.

That is, the optical modulator driving circuit 310 operates the diffractive optical modulator 110 not only during forward scanning but also during reverse scanning, thereby modulating incident light and, therefore, creating diffracted light having image information.

Thereafter, the light source switching unit 314 selectively supplies power to the laser light sources 106R, 106G and 106B. Furthermore, the scanning control unit 312 controls the scanner 116b of the projection and scanning optical unit 116 such that forward scanning and reverse scanning are sequentially performed. Preferably, the scanning control unit 312 performs control such that the speed at which a scanning line passes through a certain point of the screen 118 during forward scanning is equal to the speed at which a scanning line passes through the same point of the screen 118 during reverse scanning.

Alternatively, the scanning control unit 312 performs control such that the speed at which a scanning line passes through a certain point of the screen 118 during forward scanning is slightly different from the speed at which a scanning line passes through the same point of the screen 118 during reverse scanning.

Meanwhile, although the horizontal scanning has been described above as an example, the above description can be applied to vertical scanning in the same manner.

Furthermore, although the open hole-based diffractive optical modulator, in which open holes are formed in the diffractive optical modulator, has been described above, the above description can be applied to a diffractive optical modulator that has similar construction and no open hole.

Furthermore, although the diffractive optical modulator includes the plurality of open holes the long sides of which are arranged in a direction identical to the direction in which the reflection members cross the substrate, it may include a plurality of open holes the long sides of which are arranged in a direction perpendicular to the direction in which the reflection members cross the substrate.

According to the present invention, the temporal optical efficiency of projected light can be increased, so that brightness can increase without changing a light source, or low-power light sources can used to achieve the same brightness.

Furthermore, according to the present invention, the maximum operational acceleration of the scanner can be lowered, thereby reducing power consumption.

Furthermore, according to the present invention, the operational frequency of the scanner can be lowered, thereby reducing power consumption.

Furthermore, according to the present invention, the operational speed of the optical modulator can be lowered, therefore the operational frequency of the memory storing data on screens can be lowered.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A forward and reverse scanning-type display device using a diffractive optical modulator, comprising:
a light source system for creating and radiating light;
one or more illumination optical units for converting the light, which is emitted from the light source system, into linear incident light;
a diffractive optical modulator for modulating the linear incident light, which is emitted from the illumination optical units, into linear diffracted light in response to driving signals;
a projection and scanning optical unit for creating an image by repeatedly and alternately scanning the linear diffracted light, which is emitted from the diffractive optical modulator, on a screen in a first direction and in a reverse direction; and
a display electronic system for outputting the driving signals to the diffractive optical modulator in intervals for the scanning in the first and reverse directions and, thereby, controlling the diffractive optical modulator such that the diffractive optical modulator can create linear diffracted light, including image information, in the intervals for the scanning in the first and reverse directions.

2. The forward and reverse scanning-type display device as set forth in claim 1, wherein the projection and scanning optical unit comprises a scanner that scans the scanning line on the screen in the first direction, scans the scanning line in the reverse direction, and repeats the above operations, thereby creating an image on the screen.

3. The forward and reverse scanning-type display device as set forth in claim 2, wherein the display electronic system comprises a scanning control unit that controls the scanner such that a speed at which the linear diffracted light passes through a specific point of the screen during the scanning in the first direction is similar to a speed at which the linear diffracted light passes through the point of the screen during the scanning in the reverse direction.

4. The forward and reverse scanning-type display device as set forth in claim 1, wherein the display electronic system comprises:
an image input unit for receiving image data from outside;
memory for storing the image data input from the image input unit;
an image data output unit for sequentially reading and outputting the image data from the memory from a first column to a last column for the intervals for the scanning in the first direction, and sequentially reading and outputting the image data from the last column to the first column in the intervals for the scanning in the reverse direction; and
an optical modulator driving circuit for providing driving signals based on the image data which is output from the image data output unit, to the diffractive optical modulator.

5. The forward and reverse scanning-type display device as set forth in claim 4, wherein the display electronic system further comprises an image pivot unit that converts the image data, which is input in a lateral direction, into image data, which is arranged in a vertical direction, by performing data transposition such that the image data, which is input to the image input unit and arranged in the lateral direction, is transposed into the image data, which is arranged in the vertical direction, and stores the vertically arranged image data in the memory.

6. The forward and reverse scanning-type display device as set forth in claim 1, wherein the diffracted light emitted from the diffractive optical modulator is diffracted light having a plurality of diffraction orders;
further comprising a filter unit that is located behind the diffractive optical modulator and passes light having a specific diffraction order, which belongs to the diffracted light having the plurality of diffraction orders, therethrough.

7. The forward and reverse scanning-type display device as set forth in claim 6, wherein the filter unit comprises:
a Fourier lens for separating the diffracted light, which is emitted from the diffractive optical modulator and has the plurality of diffraction orders, according to diffraction order; and
a filter for selecting the diffracted light having a specific diffraction order from the diffracted light having the plurality of diffraction orders that is passed through the Fourier lens, and passing the diffracted light having a specific diffraction order therethrough.

8. The forward and reverse scanning-type display device as set forth in claim 1, wherein:
the light source system comprises a red light source, a green light source and a blue light source; and
the display electronic system comprises a light source control unit that controls the light source system such that red light, green light and blue light are sequentially output.

9. The forward and reverse scanning-type display device as set forth in claim 1, wherein:
the light source system comprises a red light source, a green light source and a blue light source; and
the display electronic system comprises a light source control unit that controls the light source system such that red light, green light and blue light are sequentially emitted;
further comprising a color wheel that is located behind the light source system and sequentially passes the red light, the green light and the blue light therethrough.

10. The forward and reverse scanning-type display device as set forth in claim 1, wherein the first direction is a lateral direction of the screen.

11. The forward and reverse scanning-type display device as set forth in claim 1, wherein the first direction is a vertical direction of the screen.

12. The forward and reverse scanning-type display device as set forth in claim 1, wherein the diffractive optical modulator comprises:
a substrate;
a plurality of first reflection members arranged to form an array, supported by the substrate, spaced apart from the substrate at center portions thereof to ensure a space, provided with reflection surfaces at upper portions thereof to reflect the incident light, and each provided with at least one open hole to pass the incident light therethrough;
a second reflection member located between the substrate and the first reflection members to be spaced apart from the first reflection members so as to ensure a space, and provided with a reflection surface to reflect light passed through and incident from the open holes of the first reflection members; and
a plurality of actuation means for varying an amount of the diffracted light, which is formed by the light reflected by the first reflection members and the second reflection member, by moving the center portions of the first reflection members toward or away from the substrate in response to the driving signals when the driving signals are input from the display electronic system.

13. The forward and reverse scanning-type display device as set forth in claim 12, wherein each of the first reflection members comprises a plurality of open holes that are arranged in a direction identical to a direction that crosses the substrate.
